(19) United States
(12) Patent Application Publication
(10) Pub. No.: US 2024/0427535 A1
(43) Pub. Date: Dec. 26, 2024

(54) IMAGE PROCESSING APPARATUS AND METHOD OF ADDING MANAGEMENT INFORMATION

(71) Applicant: SHARP KABUSHIKI KAISHA, Sakai City (JP)

(72) Inventors: Fusayuki FUJITA, Sakai City (JP); Masaya ISHIHARA, Sakai City (JP)

(21) Appl. No.: 18/748,028

(22) Filed: Jun. 19, 2024

(30) Foreign Application Priority Data
Jun. 20, 2023 (JP) 2023-101020

(51) Int. Cl. G06F 3/12; H04N 1/32

(52) U.S. Cl. CPC G06F 3/1222; G06F 3/1238; H04N 1/32133; H04N 2201/3269

(57) ABSTRACT

An image processing apparatus includes: an image processor which performs image processing; an authenticator which authenticates an administrator; a management information collector which collects management information related to the image processing; a management information necessity determiner which determines whether or not to add, as an image, a code related to the management information to data subjected to the image processing; a determination condition setter which receives a setting of a determination condition for use in the determination restrictively from the authenticated administrator; a management information superimposing member which superimposes the code related to the management information on the data as an image, based on the determination condition; and an output controller which controls an output of the data to which the image related to the management information is added or not added.

### CROSS-REFERENCE TO RELATED APPLICATION

The present application claims priority from Japanese Application JP2023-101020, the content to which is hereby incorporated by reference into this application.

### BACKGROUND OF THE INVENTION

### 1. Field of the Invention

The present disclosure relates to an image processing apparatus having the function of adding, to data subjected to image processing, management information related to the image processing, and a method of adding management information related to image processing.

### 2. Description of the Related Art

In accordance with extensive function enhancement of image forming apparatuses, there are known image forming systems which add printing environment information, such as a print mode, on a printed material in advance by a digital watermark or a barcode, and cause print processing to be performed on the basis of the added printing environment information. Further, there has been proposed an image forming system capable of flexibly setting or changing the secrecy of the printing environment information by adding URL information regarding a web server in which pieces of printing environment information are accumulated to a barcode. By the use of the barcode, a dedicated tool is not required for decoding, and the secrecy of the printing environment information can be set or changed by managing the access authority of the web server.

In addition, there is known a system which records history information regarding a job processed by an image processing apparatus together with an image, thereby suppressing unauthorized use of the image processing apparatus and facilitating tracing of a path when information leakage occurs. The system is configured to save the histories of the jobs of the image processing apparatus and the images that have been output or transmitted in a management server, and allow the saved information to be searched for and browsed through access to the management server later.

### SUMMARY OF THE INVENTION

It is considered that unauthorized use and information leakage can be suppressed by superimposing, as an image, information regarding a job history or the like or access information to the location of the job history on data subjected to image processing, i.e., print data or scan data, for example. An example of a method of representing such information by an image includes codes such as a one-dimensional code and a two-dimensional code. While a code can be visually recognized by a person, the content indicated by the code cannot be directly ascertained. Unlike the printing environment information, the information regarding the job history or the like or the access information to the job history or the like can be regarded as information used by an administrator, and not information used by a user such as a data sender or a data receiver. In other words, it can be said that the aforementioned information is unnecessary for the user such as the sender or the receiver. However, despite the unnecessity of the information, if the user is allowed to make the setting to prevent such kinds of information from being added, not only is the setting against the intention of the administrator, but also the advantage of being able to suppress unauthorized use and information leakage cannot be obtained.

The present disclosure has been conceived in view of the above circumstances, and provides a technique capable of suppressing unauthorized use and information leakage with a simple configuration which superimposes, as an image, a code that is related to information pertaining to management or access information to the location of the information on data subjected to image processing. Further, the present disclosure provides a technique capable of preventing a general user from changing the setting related to the content of the code and the necessity of the superimposition.

The present disclosure provides an image processing apparatus including: an image processor which performs image processing; an authenticator which authenticates an administrator; a management information collector which collects management information related to the image processing; a management information necessity determiner which determines whether or not to add, as an image, a code related to the management information to data subjected to the image processing; a determination condition setter which receives a setting of a determination condition for use in the determination restrictively from the authenticated administrator; a management information superimposing member which superimposes the code related to the management information on the data as an image, on the basis of the determination condition; and an output controller which controls an output of the data to which the image related to the management information is added or not added.

Also, from another aspect, the present disclosure provides a method of adding management information related to image processing, in which the method is executed by one or more controllers of an image processing apparatus and includes: a step of authenticating an administrator by using an authenticator; a step of collecting management information related to image processing; a determination step of determining whether or not to add, as an image, a code related to the management information to data subjected to the image processing; a step of receiving a setting of a determination condition for use in the determining of the determination step restrictively from the authenticated administrator; a step of superimposing the code related to the management information on the data as an image, on the basis of the determination condition; and a step of outputting the data to which the image related to the management information is added or not added.

The image processing apparatus according to the present disclosure includes the management information necessity determiner which determines whether or not to add, as an image, a code related to management information to data subjected to image processing, and the determination condition setter which receives a setting of a determination condition for use in the determination restrictively from the authenticated administrator. Therefore, it is possible to suppress unauthorized use and information leakage with a simple configuration which superimposes, as an image, a code related to management on the data subjected to image processing. Since the code to be superimposed can be visually recognized by anyone who sees the data, the code can be recognized as the managed data. However, since the contents of the management information cannot be directly ascertained from the code, the confidentiality of the management information is maintained. In addition, since the determination condition setter does not receive a setting of the determination condition from a general user but receives only the setting from the administrator, it is possible to prevent the general user who may be involved with unauthorized use or information leakage from changing the setting related to the content of the code and the necessity of the superimposition.

The method of adding management information according to the present disclosure also exhibits similar effects and advantages.

### BRIEF DESCRIPTION OF THE DRAWINGS

FIG. 1 is an explanatory diagram illustrating an example of connection between an image processing apparatus according to the present disclosure and an external device associated with the image processing apparatus in an embodiment of the present disclosure.

FIG. 2 is a block diagram illustrating a configuration example of the image processing apparatus shown in FIG. 1.

FIG. 3 is a first flowchart showing a flow of processing executed by a controller indicated in FIG. 2 in relation to addition of management information.

FIG. 4 is a second flowchart showing a flow of processing executed by the controller indicated in FIG. 2 in relation to the addition of the management information.

FIG. 5 is an explanatory diagram illustrating an example of setting items related to addition of management information received by a determination condition setter indicated in FIG. 2.

FIG. 6 is an explanatory diagram showing an example of a code to be superimposed on document data by a management information superimposing member indicated in FIG. 2.

FIG. 7 is an explanatory diagram showing an example, which is different from the example of FIG. 6, of a code to be superimposed on document data by the management information superimposing member indicated in FIG. 2.

### DETAILED DESCRIPTION OF THE INVENTION

The present disclosure will be described in more detail with reference to the accompanying drawings. The following description is illustrative in all respects and should not be construed as limiting the present disclosure. In the present disclosure, management information refers to information for use by an administrator to manage information related to image processing. The management information is information used by an administrator of the information mainly for the purpose of preventing an image processing apparatus from being used by an unauthorized outsider or preventing the information, which is managed by a business entity or an organization where an image processing apparatus is installed, from being intentionally transmitted to the outside by using the image processing apparatus, or making it possible to trace, when such unauthorized use or information leakage occurs, the unauthorized use or the information leakage. Examples of the management information include a date and time of execution of the image processing, identification information for identifying the apparatus that has performed the image processing, and information related to an output destination of the data relating to a job. Specific examples of the information related to the output destination include, for example, a destination telephone number when the job is a fax job, and an e-mail address or an Internet Protocol (IP) address of a transmission destination when the job is a scan job. The management information may include information, which is other than the above-described date and time, identification information, and output destination, relating to a history of the job executed by the image processing apparatus. According to this mode, information related to the contents of the management information and a location such as the date and time of the execution of the image processing, the apparatus, and the output destination of the data, are added as an image in the form of a code to an image to be output. By virtue of this feature, it is possible to suppress the unauthorized use and information leakage.

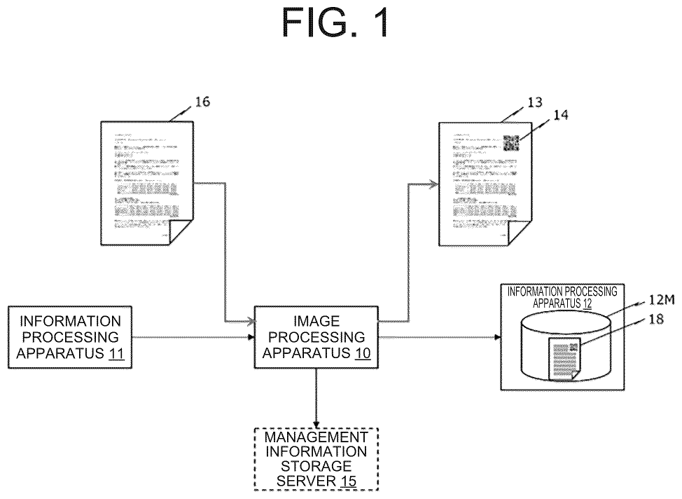

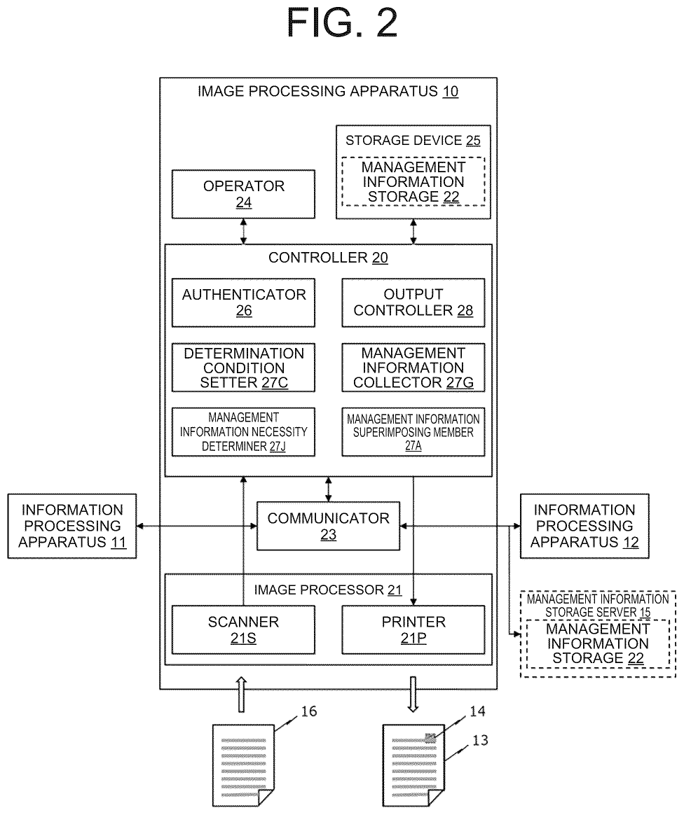

FIG. 1 is an explanatory diagram illustrating an example of connection between an image processing apparatus according to the present disclosure and an external device associated with the image processing apparatus in an embodiment of the present disclosure. FIG. 2 is a block diagram illustrating a configuration example of the image processing apparatus shown in FIG. 1. As illustrated in FIG. 1, an image processing apparatus 10 is connected to an information processing apparatus 11 via a network. The image processing apparatus 10 receives and executes a print job from the information processing apparatus 11, and outputs a print output 13 on which a code 14 related to management information is superimposed as an image. Also, the image processing apparatus 10 executes a scan job of reading a document 16, and transmits, to an information processing apparatus 12 connected via the network, scan data 18 with a code related to management information being superimposed on an image of the document 16. The information processing apparatus 12 which has received the scan data of the document 16 stores the received scan data in a storage device 12M. Further, when a copy job is to be executed, the document 16 is read, an image of the code 14 related to the management information regarding the copy job is generated, and the print output 13 on which the generated image is superimposed is output.

The image processing apparatus 10 may be connected to a management information storage server 15 via the network. The management information storage server 15 is a server which stores the management information transmitted from the image processing apparatus 10 such that an administrator can refer to the management information. However, there may also be a mode in which the image processing apparatus 10 stores the management information in an internal storage device, so that the management information storage server 15 is not provided. FIG. 1 illustrates only one image processing apparatus 10. However, when there exists the management information storage server 15, the management information storage server 15 is able to store management information related to one or more image processing apparatuses that are connected by way of communication.

As illustrated in FIG. 2, the image processing apparatus 10 is provided with a controller 20, an image processor 21, a communicator 23, an operator 24, and a storage device 25. The controller 20 includes an authenticator 26, a management information superimposing member 27A, a determination condition setter 27C, a management information collector 27G, a management information necessity determiner 27J, and an output controller 28. The image processor 21 is provided with a printer 21P and a scanner 21S. Further, the storage device 25 may be provided with a management information storage 22. Instead of or in addition to the above, the management information storage server 15 may include the management information storage 22. As a preferable mode, the management information storage 22 stores images related to jobs (for example, the images related to jobs such as an image of the document 16 read by the scanner 21S, an image used for printing by the printer 21P, and the like) together with the management information. In addition, as a preferable mode, the storage device 25 or the management information storage server 15 stores images related to jobs (for example, the images related to jobs such as an image of the document 16 read by the scanner 21S, an image used for printing by the printer 21P, and the like) in association with the management information. According to this mode, the user can also refer to the image associated with the management information when referring to the management information.

The controller 20 controls each constituent element of the image processing apparatus 10, and is mainly composed of a processor and a memory as hardware resources. As the processor executes a program stored in the memory, the function of the controller 20 is implemented. In other words, hardware and software are organically combined to implement the function of the controller 20.

The image processor 21 includes a mechanism and a circuit which perform image-related processing. The printer 21P forms an image on a sheet, and includes, for example, a circuit which generates image data on the basis of a print job received from the information processing apparatus 11, a printing mechanism which forms, on the basis of the image data, a visible image by an electrophotographic method, an inkjet method, or the like, and a processor which controls the operation of the circuit and the printing mechanism. The scanner 21S reads a document, and includes, for example, a mechanism which conveys a document, a mechanism which scans the document, an image sensor, an image processing circuit which processes a signal from the image sensor, and a processor which controls image processing.

The communicator 23 is a communication circuit which communicates with an external device connected via the network under the control of the controller 20. The operator 24 includes a display device which provides a user with information related to a job or the state of the image processing apparatus 10, and an operation detection device such as a touch panel which receives a user operation. The storage device 25 is configured from a storage device such as a hard disk drive (HDD) or a solid state drive (SSD), and stores data. The storage device 25 may store the management information, and in that case, the storage device 25 includes the management information storage 22. The above configuration is referred to as Embodiment 1 of the present disclosure. However, such a mode in which the storage device 25 is not provided with the management information storage 22, but the management information storage server 15 is provided with the management information storage 22 may be adopted. The above configuration is referred to as Embodiment 2 of the present disclosure. Also, such a mode in which both the storage device 25 and the management information storage server 15 are provided with the management information storage 22 may be adopted. The above configuration is referred to as Embodiment 3 of the present disclosure.

The authenticator 26 performs processing related to user authentication. The target of the user authentication is an administrator, and a general user may also be the target of authentication. An authentication method is one that uses an ID and a password, for example. However, the authentication method is not limited thereto, and may be, for example, biometric authentication. The management information collector 27G performs the processing of collecting the management information in executing the image processing. The collected management information is converted into a code and is superimposed on output data by the management information superimposing member 27A, which will be described later. Alternatively, the collected management information is stored in the management information storage 22. The management information superimposing member 27A converts the management information or information for accessing the management information into a code, and performs the processing of superimposing the code, as an image, on the output data. According to this mode, the image related to the management information that has been added to data can be used to access the management information related to the data. The management information necessity determiner 27J determines whether or not a code is to be superimposed on the output data. The determination condition setter 27C receives the setting of a determination condition to be used when the management information necessity determiner 27J performs the determination. However, the setting of the determination condition to be received is only the setting made by an administrator who has been registered in advance and authenticated by the authenticator 26, and the setting by the others is not received.

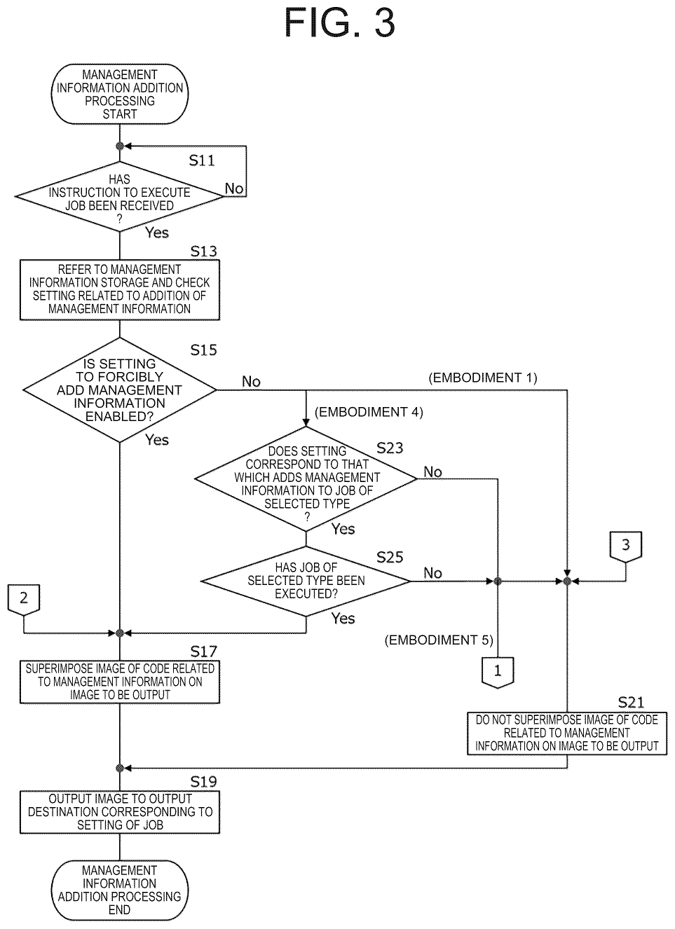

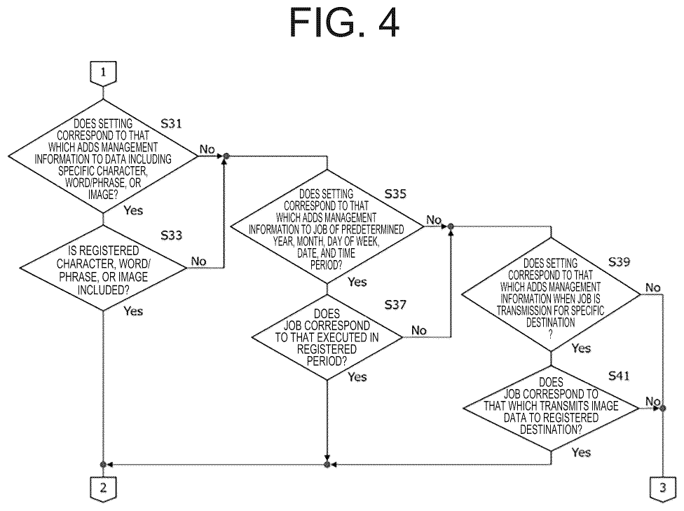

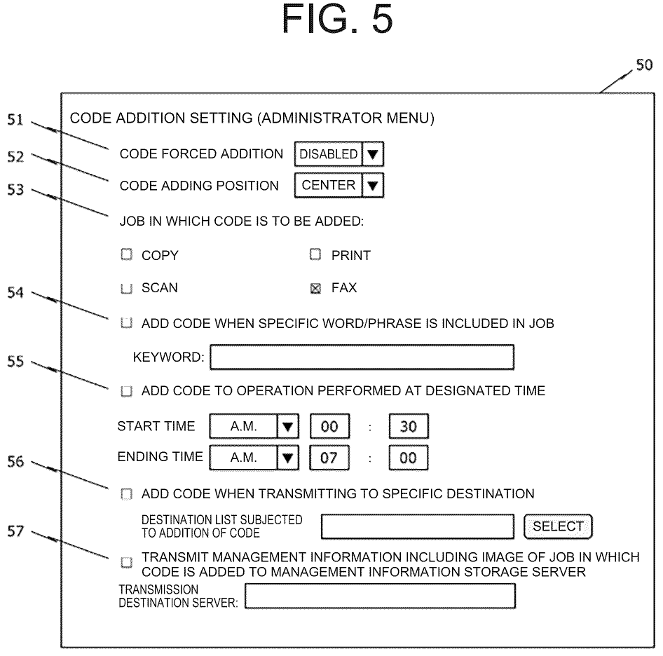

FIGS. 3 and 4 are flowcharts showing an example of a flow of processing executed by the controller 20 in relation to addition of the management information. As indicated in FIG. 3, when the controller 20 receives an instruction (Yes in step S11) to execute any type of job (for example, a print job from the information processing apparatus 11), the controller 20 refers to the management information storage 22 and checks the setting related to addition of the management information (step S13). FIG. 5 illustrates an administrator menu screen 50 which receives the setting related to addition of the management information according to the present embodiment. An administrator menu is a setting menu related to control of the image processing apparatus 10 which receives the setting restrictively from an authenticated administrator. Among the setting items of the setting menu, an example of the items related to the addition of the management information is illustrated in FIG. 5. As illustrated in FIG. 5, the administrator menu screen receives the setting for the following items made by the authenticated administrator.

A code forced addition setting 51 indicated in FIG. 5 is a setting of whether or not to superimpose, as an image, a code related to the management information on the output data of all of the jobs executed by the image processing apparatus 10. The determination condition setter 27C receives the setting to either enable or disable this item. Note that when the code forced addition setting 51 is set to “Enabled”, the determination condition setter 27C does not receive the setting of the items of an addition target word or phrase setting 54, an addition target time period setting 55, and an addition target destination setting 56, which will be described later. The management information necessity determiner 27J determines that a code related to the management information should be added regardless of the conditions of those items. Therefore, when the code forced addition setting 51 is set to “Enabled”, the determination condition setter 27C may gray out the items of the addition target word or phrase setting 54, the addition target time period setting 55, and the addition target destination setting 56 to display that the setting is not received.

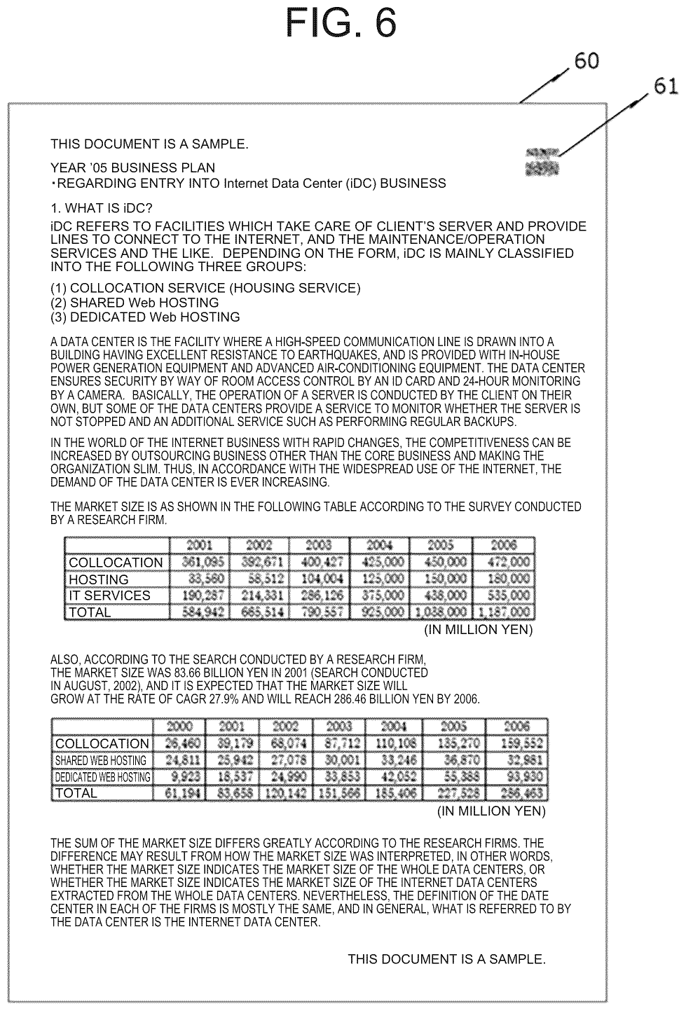

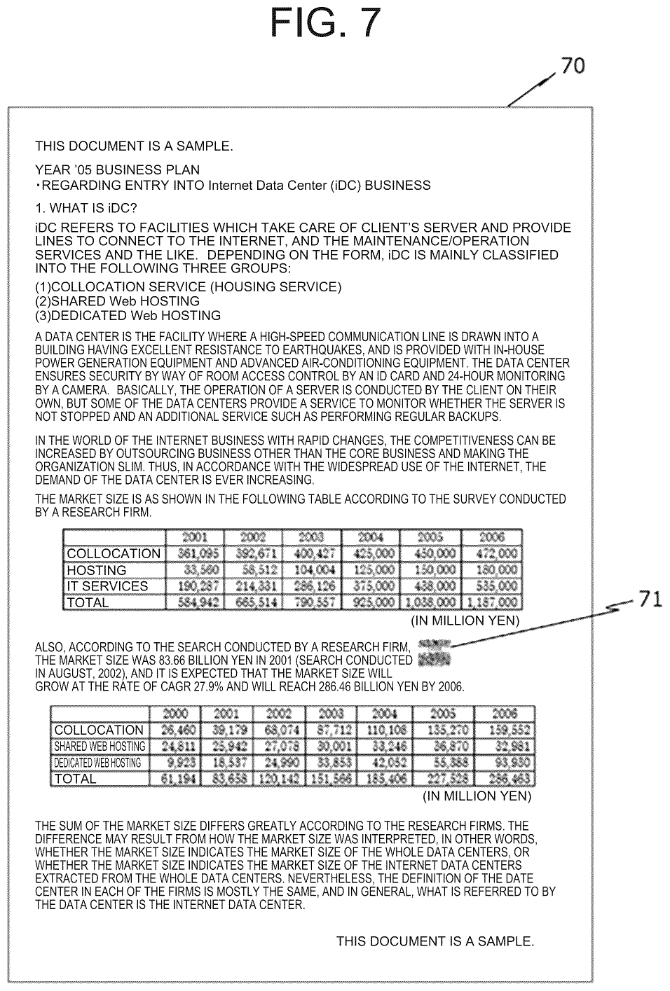

A code adding position setting 52 receives the setting of at which position in the output data the management information superimposing member 27A is to superimpose the code. In one example, an option of the setting to be received is any one of “upper part”, “center”, and “lower part”. FIG. 6 illustrates an example of the position where the code is superimposed when the “upper part” is set. In a print output 60 illustrated in FIG. 6, a code 61 related to the management information is a two-dimensional code that is printed on the right side of an upper end portion of the print output 60. When the “upper part” is set as the code adding position setting 52, the management information superimposing member 27A prints the code in a blank portion, which is inside a rectangular area where a document is printed and which does not overlap the document, and not in a margin area at the upper part of the document. This is because if a code is printed in a margin area, a portion corresponding to the code, which is unnecessary information for the user, may be cut off. However, as illustrated in FIG. 6, when the “upper part” is set as the code adding position setting 52, the code may be cut off even if the code is not in the margin area. As a more preferable mode for the document, the code can be set to a central part. FIG. 7 illustrates an example of the position where the code is superimposed when the “central part” is set. In a print output 70 illustrated in FIG. 7, a code 71 related to the management information is printed in a blank portion which does not overlap the document and which is near the right side in the middle of the print output 70. Since the code is printed at the central part, it is less likely that a portion corresponding to the code will be cut off as compared with the case where the code is printed on the upper part or the lower part. This is because damage to the document will be greater when such a portion is to be cut off. According to this mode, the code related to the management information is superimposed as an image not on the periphery of the document but in the area inside the document. Therefore, it is possible to prevent the management information from being separated from the document by removal of the margin of the output data.

An addition target job setting 53 receives the type of a job in which the code related to the management information is to be added. In the example illustrated in FIG. 5, the determination condition setter 27C receives the setting for four jobs, i.e., a copy job, a print job, a scan job, and a fax job, individually. If the management information necessity determiner 27J finds a job for which a check box is checked, the management information necessity determiner 27J superimposes, as an image, a code related to the management information on the image related to an output of the job.

The addition target word or phrase setting 54 receives the setting to add, when the image related to an output of the job includes a specific character or word or phrase, a code related to the management information to that job. Specifically, the determination condition setter 27C stores the characters and words or phrases that have been input in a keyword field as being registered characters and words or phrases. Although not illustrated in FIG. 5, registration of an image (a pixel pattern) may be received in addition to or instead of the characters and words or phrases. Regardless of a difference between the targets of registration, i.e., even if the target of registration is an image and not a character, also in the case of the image, determination of whether or not the image matches with the registered content, and the processing to be performed based on the determination are the same. When it is determined by the management information necessity determiner 27J that the registered character or word or phrase is included in the image of the job, the management information necessity determiner 27J superimposes, as an image, a code related to the management information on the image related to the output of that job. Further, the addition target time period setting 55 receives the setting to add, when image processing is executed in a specific time period, a code related to the management information to that job. Specifically, the determination condition setter 27C receives registration of the start time and the ending time and stores the registration. When it is determined by the management information necessity determiner 27J that a job has been executed within a time period defined by the registered start time and ending time, the management information necessity determiner 27J superimposes, as an image, a code related to the management information on the image related to the output of that job. Furthermore, the addition target destination setting 56 receives the setting to add, when output data of the job is transmitted to a specific destination, a code related to the management information to that job. Specifically, the determination condition setter 27C stores the file of a destination list input to a reference destination of the destination list as being a registered file. When it is determined by the management information necessity determiner 27J that a transmission destination of the output data of the job corresponds to the destination of the registered file list, the management information necessity determiner 27J superimposes, as an image, a code related to the management information on the image related to the output of that job. A transmission destination server setting 57 receives the setting of a transmission destination, which is the setting to transmit the management information to the management information storage server 15, when the management information storage server 15 is provided. The determination condition setter 27C stores the transmission destination in the field of the transmission destination server. The management information collector 27G transmits the collected management information to the transmission destination registered in the field of the transmission destination server, and causes the management information to be stored in the management information storage 22 provided in the management information storage server 15.

Now, the flowchart description is continued. When the controller 20 has referred to the management information storage 22 and checked the setting related to the addition of the management information, the controller 20 as the management information necessity determiner 27J checks whether or not the code forced addition setting 51 is set to “Enabled” (step S15). If the code forced addition setting 51 is set to “Enabled” (Yes in step S15), the controller 20 as the management information necessity determiner 27J determines that a code related to the management information should be superimposed. In accordance with the determination result, the management information superimposing member 27A superimposes an image of the code related to the management information on the output data of the job to be executed at a position corresponding to the setting of the code adding position setting 52 (step S17). Then, the output controller 28 outputs an image to an output destination corresponding to the setting of the job (step S19), and ends execution of the job.

Meanwhile, in the determination of step S15 described above, if it is determined that the code forced addition setting 51 is set to “Disabled” (NO in step S15), there may a mode in which a code related to the management information is not added in any kind of job. This mode is referred to as a basic mode (Embodiment 1). In the case of Embodiment 1, the controller 20 as the management information necessity determiner 27J does not add an image of the code related to the management information to the output data of the job to be executed (step S21). Then, the processing is advanced to step S19 described above, and the output controller 28 outputs an image to the output destination corresponding to the setting of the job, and ends the execution of the job.

However, there may a mode in which a more detailed determination condition is used. Such a mode (Embodiment 4) will be described below. When the code forced addition setting 51 is set to “Disabled” (No in step S15), the controller 20 as the management information necessity determiner 27J checks whether or not the setting is made by the addition target job setting 53 to add a code in any one of the jobs (step S23). If the setting is made to add a code in any one of the jobs (Yes in step S23), the controller 20 subsequently checks whether or not the job to be executed corresponds to a job of the type set to add a code (step S25). If the job to be executed corresponds to a job set to add a code (Yes in step S25), the controller 20 as the management information necessity determiner 27J determines that a code related to the management information should be superimposed. A mode of determining whether or not to add a code related to the management information on the basis of the addition target job setting 53 will be described as Embodiment 4. According to this mode, by allowing the management information to be added only when the job is one which transmits data, for example, it is possible to make the setting of whether or not to add a code related to the management information according to the type of a job related to image processing. Thus, it is possible to change the handling of a job to be managed by the image processing apparatus against unauthorized use and information leakage and a job to be managed by the other devices or instruments. By doing so, it is possible to prevent an unnecessary management code from being superimposed on the output data of a job which does not need to be managed. In accordance with the determination result of step S25, the management information superimposing member 27A advances the processing to step S17 described above, and superimposes an image of the code related to the management information on the output data of the job to be executed at a position corresponding to the setting of the code adding position setting 52. The subsequent processing is as described above.

In the determination of step S23 described above, if it is determined that none of the jobs is set to add a code by the addition target job setting 53 (No in step S23), there may a mode in which the controller 20 as the management information necessity determiner 27J does not add a code related to the management information. In that case, the processing is advanced to step S21 described above, and an image of the code related to the management information is not added to the output data of the job to be executed (step S21). Then, the processing is advanced to step S19, and the output controller 28 outputs an image to the output destination corresponding to the setting of the job, and ends the execution of the job. However, there may a mode in which a further detailed determination condition is used. This mode is referred to as Embodiment 5.

In Embodiment 5, the controller 20 as the management information necessity determiner 27J executes the following processing. Note that in Embodiment 5, it is assumed that the following processing is similarly executed in a case where it is determined in the determination of step S25 described above that the job to be executed does not correspond to a job of the type set to add a code (i.e., the case of “NO” in step S25). The controller 20 as the management information necessity determiner 27J checks whether or not the addition target word or phrase setting 54 is set (step S31 shown in FIG. 4). If the addition target word or phrase setting 54 is set (Yes in step S31), the controller 20 subsequently checks whether or not any character or word or phrase is registered, and whether or not the character or word or phrase is included in the image related to the job (step S33). If the registered character or word or phrase is included in the image related to the job (Yes in step S33), the controller 20 as the management information necessity determiner 27J determines that a code related to the management information should be superimposed. For example, when words such as “Confidential” and “restricted to the department” are registered, and the image related to the job includes the registered words, a code related to the management information is superimposed. According to this mode, in a case where at least one of a specific character, a specific word or phrase, and a specific image is included in the data for which the image processing has been performed, a code related to the management information is added, so that it is possible to suppress unauthorized use and information leakage. By virtue of this feature, it is possible to prevent an unnecessary management code from being superimposed on the output data in the other cases. In accordance with a determination result of step S33, the management information superimposing member 27A advances the processing to step S17 indicated in FIG. 3, and superimposes an image of the code related to the management information on the output data of the job to be executed at a position corresponding to the setting of the code adding position setting 52. Then, the output controller 28 outputs an image to an output destination corresponding to the setting of the job (step S19), and ends execution of the job.

In the determination of step S31 described above, if it is determined that the addition target word or phrase setting 54 is not set (No in step S31), the controller 20 as the management information necessity determiner 27J executes the following processing. The same applies to a case where it is determined in step S33 described above that a character or a word or phrase is not registered or the registered character or word or phrase is not included in the image related to the job (i.e., the case of “No” in step S33). The controller 20 as the management information necessity determiner 27J checks whether or not the addition target time period setting 55 is set (step S35). If the addition target time period setting 55 is set (Yes in step S35), the controller 20 subsequently checks whether or not any time period is registered, and whether or not execution of the job is included in that time period (step S37). If the execution of the job is included in the registered time period (Yes in step S37), the controller 20 as the management information necessity determiner 27J determines that a code related to the management information should be superimposed. According to this mode, in a case where the image processing is performed in at least one of the registered year, month, day of the week, date, and time period, a code related to the management information is added, so that it is possible to suppress unauthorized use and information leakage. By virtue of this feature, it is possible to prevent an unnecessary management code from being superimposed on the output data in the other cases. In accordance with a determination result of step S37, the management information superimposing member 27A advances the processing to step S17 indicated in FIG. 3, and superimposes an image of the code related to the management information on the output data of the job to be executed at a position corresponding to the setting of the code adding position setting 52. Then, the output controller 28 outputs an image to an output destination corresponding to the setting of the job (step S19), and ends execution of the job.

In the determination of step S35 described above, if it is determined that the addition target time period setting 55 is not set (No in step S35), the controller 20 as the management information necessity determiner 27J executes the following processing. The same applies to a case where it is determined in step S37 described above that the time period is not registered or the execution of the job is not included in the registered time period (i.e., the case of “No” in step S37). The controller 20 as the management information necessity determiner 27J checks whether or not the addition target destination setting 56 is set (step S39). If the addition target destination setting 56 is set (Yes in step S39), the controller 20 subsequently checks whether or not any destination is registered, and whether or not the destination of the output data related to the job to be executed matches with the destination in question (step S41). If the destination of the output data related to the job to be executed matches with the registered destination (Yes in step S41), the controller 20 as the management information necessity determiner 27J determines that a code related to the management information should be superimposed. According to this mode, in a case where data is transmitted to the registered destination, a code related to the management information is added, so that it is possible to suppress unauthorized use and information leakage. By virtue of this feature, it is possible to prevent an unnecessary management code from being superimposed on the output data in the other cases. In accordance with a determination result of step S41, the management information superimposing member 27A advances the processing to step S17 indicated in FIG. 3, and superimposes an image of the code related to the management information on the output data of the job to be executed at a position corresponding to the setting of the code adding position setting 52. Then, the output controller 28 outputs an image to an output destination corresponding to the setting of the job (step S19), and ends execution of the job.

In the determination of step S39 described above, if it is determined that the addition target destination setting 56 is not set (No in step S39), the controller 20 as the management information necessity determiner 27J performs the following processing. The same applies to a case where it is determined in step S41 described above that the destination of the output data related to the job to be executed is not registered or does not match with the registered destination (i.e., the case of “No” in step S41). The controller 20 as the management information necessity determiner 27J advances the processing to step S21 indicated in FIG. 3, and does not add an image of the code related to the management information to the output data of the job to be executed. The output controller 28 outputs an image to an output destination corresponding to the setting of the job (step S19), and ends execution of the job. Described above is the flow of the processing executed by the controller 20 in relation to the addition of the management information.

It should be understood that the present disclosure includes combinations of any of the above-described modes.

Various modifications can be made to the present disclosure in addition to the above-described embodiments. Such modifications should not be construed as falling outside the scope of the present disclosure. The invention according to the present disclosure should include the claims and their equivalents, and all modifications belonging to the scope of the present disclosure.

Moreover, each functional block or various features of the apparatus used in the embodiments described above may be implemented in or executed by an electrical circuit such an integrated circuit or a plurality of integrated circuits. The electric circuit designed to execute the functions described in the present specification may include a general-purpose processor, a digital signal processor (DSP), an application-specific integrated circuit (ASIC), a field-programmable gate array (FPGA) or other programmable logic devices, a discrete gate or transistor logic, discrete hardware components, or a combination of the aforementioned elements. The general-purpose processor may be a microprocessor or a conventional processor, a controller, a microcontroller, or a state machine. The above-described electric circuit may be configured by a digital circuit or by an analog circuit. Moreover, when a technology for forming an integrated circuit which could substitute for the current integrated circuits emerges as a result of the progress of the semiconductor technology, it is possible to use a new integrated circuit based on such technology for one or more aspects of the present disclosure.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An image processing apparatus comprising:
an image processor which performs image processing;
an authenticator which authenticates an administrator;
a management information collector which collects management information related to the image processing;
a management information necessity determiner which determines whether or not to add, as an image, a code related to the management information to data subjected to the image processing;
a determination condition setter which receives a setting of a determination condition for use in the determination restrictively from the authenticated administrator;
a management information superimposing member which superimposes the code related to the management information on the data as an image, based on the determination condition; and
an output controller which controls an output of the data to which the image related to the management information is added or not added.

2. The image processing apparatus according to claim 1, wherein:
the management information includes information from which a date and time of execution of the image processing and an apparatus which has performed the image processing are identifiable, and information related to an output destination of the data; and
the management information superimposing member superimposes the code related to the management information on the data as an image.

3. The image processing apparatus according to claim 1, wherein the management information necessity determiner receives a selection of a part of or all of types of jobs related to the image processing, and determines that the management information is to be added to the selected job.

4. The image processing apparatus according to claim 1, wherein the management information necessity determiner receives registration of at least one of a specific character, a specific word or phrase, and a specific image, and determines that the management information is to be added when the data includes a registered keyword, word or phrase, or image.

5. The image processing apparatus according to claim 1, wherein the management information necessity determiner receives registration of at least one of a year, a month, a day of the week, a date, and a time period, and determines that the management information is to be added when the image processing is performed in at least one of the registered year, month, day of the week, date, and time period.

6. The image processing apparatus according to claim 1, wherein:
the output of the data controlled by the output controller includes a transmission of the data; and
the management information necessity determiner receives registration of a destination of the data, and determines that the management information is to be added when an output destination of the data represents a transmission to the registered destination.

7. The image processing apparatus according to claim 1, further comprising a management information storage which stores data including the data associated with the management information, wherein
the image related to the management information indicates a reference destination of the data stored in the management information storage.

8. The image processing apparatus according to claim 1, wherein:
the data subjected to the image processing is data related to a document; and
the management information superimposing member superimposes, as an image, the code related to the management information at an area excluding a margin at a periphery of the document.

9. A method of adding management information related to image processing, the method being executed by one or more controllers of an image processing apparatus and comprising:
authenticating an administrator by using an authenticator;
collecting management information related to image processing;
determining whether or not to add, as an image, a code related to the management information to data subjected to the image processing;
receiving a setting of a determination condition for use in the determining restrictively from the authenticated administrator;
superimposing the code related to the management information on the data as an image, based on the determination condition; and
outputting the data to which the image related to the management information is added or not added.
